(19) United States
(12) Patent Application Publication
(10) Pub. No.: US 2010/0256781 A1
(43) Pub. Date: Oct. 7, 2010

(54) Semantic appliance control system

(76) Inventor: Chen-Yu Sheu, Irvine, CA (US)

Correspondence Address: Chen-Yu Sheu, 7 WHISTLER CT, IRVINE, CA, 92617, US

(21) Appl. No.: 12/384,054

(22) Filed: Apr. 1, 2009

(51) Int. Cl. G05B 19/02; G05B 11/01; G06F 17/00; G06N 5/02

(52) U.S. Cl. 700/3; 700/17; 706/59; 706/47

(57) ABSTRACT

This invention provides a semantic appliance control system consisting of a computer or cellphone interface that allows a user to compose command sentences remotely; one or more control boxes that each can send and/receive control signals to/from one or more specific appliances; and a control software on a server that receives and compiles a command sentence from a user into one or more control commands. The control software further schedules the control commands from one or more users and sends each control command to one or more control boxes at one or more scheduled times. The control box may as well include one or more sensors to collect and report the status of the appliance and the environment. Users may assert a set of rules in the control software such that whenever the status of an appliance or the environment satisfies certain condition(s), the control software may take one or more user-specified actions or that it can enforce certain conditions be satisfied all the time. The invention basically extends any existing appliance with user programmability. With the control software and a control box, a user may “program” or control the operations of an appliance remotely from a cellphone or a computer for personalized comfort, better performance and/or energy saving.

### BACKGROUND OF THE INVENTION

1. Field of the Invention

This invention is related to a semantic appliance control system that allows users to issue descriptive command sentences remotely to control an appliance from a cellphone or a computer via a server and a local control box.

2. Description of the Related Art

For many years vendors have tried to provide “smart” appliances with embedded intelligence. It is however less understood how an existing appliance can be turned into a “smart” appliance. This invention is also different from any “smart” appliance (including cable TV) in that a user does not directly operate an appliance via a (separate or embedded) control box; rather operations of an appliance are “programmed” using a descriptive (semantic) language that can be understood by a control software on a remote server that communicates with the appliance using a control box that is also a part of this invention.

### SUMMARY OF THE INVENTION

For purposes of summarizing the invention, certain aspects, advantages and novel features of the invention have been described herein. It should be understood that not necessarily all such aspects, advantages or features will be embodied in any particular embodiment of the invention.

This invention provides a semantic appliance control system consisting of a computer or cellphone interface that allows a user to compose command sentences remotely; one or more control boxes that each can send and/receive control signals to/from one or more specific appliances; and a control software on a server that receives and compiles a command sentence from a user into one or more control commands. The control software further schedules the control commands from one or more users and sends each control command to one or more control boxes at one or more scheduled times. The control box may as well include one or more sensors to collect and report the status of the appliance and the environment. Users may assert a set of rules in the control software such that whenever the status of an appliance or the environment satisfies certain condition(s), the control software may take one or more user-specified actions or that it can enforce certain conditions be satisfied all the time.

The invention basically extends any existing appliance with user programmability. With the control software and a control box, a user may “program” or control the operations of an appliance remotely from a cellphone or a computer for personalized comfort, better performance and/or energy saving.

### DETAILED DESCRIPTION OF THE PREFERRED EMBODIMENT

The following subsections describe a semantic appliance control system that embodies various inventive features. The various inventive features can be implemented differently than described herein. Thus, the following description is intended only to illustrate, and not limit, the scope of the present invention.

### A Semantic Appliance Control System

FIG. 1 illustrates one embodiment of a semantic appliance control system 100. The semantic appliance control system 100 allows a user without programming skills to create a command sentence to control an existing appliance.

The cell phone 110 could be any ordinary cellphone that can be connected to the control software 130 using a cellphone communication network (such as GPRS, CDMA). The computer 120 could be any ordinary computer that can be connected to the control software via using a computer communication network (such as HTTP, WiFi). In either case, with a standard cellphone interface or browser interface, a user can select a verb (action), a noun (appliance) and one or more constraints (modifiers), and combine them into a command sentence and send it to the control software 130.

The control box 140 may be a device separated from the appliance 150 or embedded in the appliance 150. The control box 140 may be connected to the control software 130 using a cellphone communication network or a computer communication network.

The control software 130 compiles a command sentence received from the user into one or more control commands that can be understood by a control box 140 and schedules their executions. It is possible that based on the constraints in a command sentence the control commands are not executed at the same time. For example a command “turn on TV1” corresponding to the command sentence “turn on TV1 at 8PM everyday” may be executed every day at 8PM. In this case the control software records the command and schedules its execution once a day.

The control software 130 executes the control commands based on their scheduled times. Whenever a control command is scheduled to execute, it is sent to the control box using a communication network.

The appliance control box 140 receives and interprets commands sent from the control software 130. It interprets each command received into one or more control signals that can be executed by the appliance 150 it controls to perform the desired operation. The control signals are transmitted via a wire or in a wireless manner (using infrared or blue tooth technology).

FIG. 2 shows the flowchart of the control sentence composition process. At block 210, the system prompts the user to select a noun (i.e., a target appliance) from a set of appliances. At block 220, the system prompts the user to select an applicable action and enter the value of each parameter, if any (blocks 230 and 240). At block 250, the system prompts the user to select one or more applicable constraints (block 260) and enter the values of their parameters (blocks 270 and 280), if desired.

The user may also assert one of more rules in the control software to control the scheduling and execution of the command sentences from the users.

FIG. 3 shows the flowchart of a rule sentence composition process. At block 310, the system prompts the user to select a noun (i.e., a target appliance) from a set of appliances. At block 320, the system prompts the user to select an applicable action and enter the value of each parameter, if any (blocks 330 and 340) when the conditions(s) are satisfied (see below). At block 350, the system prompts the user to select one or more applicable conditions (block 360) and enter the values of their parameters (blocks 370 and 380), if desired.

FIG. 4 shows the flowchart of the composition process for rules of another style. At block 410, the system prompts the user to select a noun (i.e., a target appliance) from a set of appliances. At block 420, the system prompts the user to select one or more applicable pre-conditions (block 430) and enter the values of their parameters (blocks 440 and 450). At block 460, the system prompts the user to select one or more applicable post-conditions (block 470) and enter the values of their parameters (blocks 480 and 490), if desired. If no post-conditions are specified, the pre-conditions have to be enforced to be TRUE all the time. As an example, a user whose ID is “John” may compose the following command sentence:

Turn on the TV (whose ID is TV1) to channel 7 every day at 8PM.

The command sentence is sent to the control software that compiles it into a command like:

### TV1#John@TurnOn(7)

which is scheduled to be executed everyday at 8PM. At 8PM of each day, the command is sent from the control software to the corresponding control box (i.e., the control box of John that controls TV1). Once received, the control box interprets the command and translates it into an infrared signal sent to TV1.

As another example, a user may assert the following rule to the control software that says no one can turn on the TV whose ID is TV1 after 11PM and before 7AM:

```
IF
    Time > 2300 and Time < 700
Then
    Status(TV1) = OFF
```

The rule is sent to the control software that understands it is a rule and enforces it to disallow any command that asks for turning on the TV after 11PM and before 7AM.

As a third example, a user may assert the following rule to the control software that says if the room temperature is at or above 70 degrees, turn off the heater whose ID is “heater 1”:

```
IF
    Temperature >=  70
Then
    Turn off heater 1
```

The rule is compiled by the control software into a command to the control box in charge of heater 1 that is equipped with a thermostat. The command requests the box to report in whenever the room temperature exceeds 70 degrees and, if that occurs, the control software schedules the execution of the action “Turn off heater 1” immediately.

### A Semantic Appliance Control Box

FIG. 5 illustrates one embodiment of the control box 140. The control box 140 consists of (1) a GSM communication module 510 that can communicate with the control software via messages; (2) a core control module 520; (3) an infrared control module 530 that can learn and transmit infrared control signals; and (4) a wire control module 540 that can transmit control signals to an appliance through a wire directly. The control module may be equipped with one or more sensors 550 to gather data about the environment (e.g., temperature) or the status of an appliance (e.g., on/off state).

### An Infrared Control Module

FIG. 6 illustrates one embodiment of the Infrared control module 530. The module consists of (1) an infrared signal input circuit 610 that decodes an infrared signal; (2) an infrared emission circuit 620 that reproduces and transmits an infrared signal stored in the memory module 630; (3) a memory module 630 that saves the decoded signals; (4) a code/storage switch 640 that encodes an address and saves it; (5) an LED 650 which indicates signal learning is in process; (6) an infrared learning circuit 660, and (6) a core micro controller MCU 670 that connects and controls all modules.

When in the learning mode, a user only needs to follow the instructions to transmit the IR signals from a remote controller of an appliance, one at a time, to the control box 100 and modulate the address switch 640 to an address to store a signal. The control box precisely analyzes each signal and stores it to a memory address. When the user wants to control the corresponding appliance with a specific signal, the control box reproduces the stored IR signal.

### BRIEF DESCRIPTION OF THE DRAWINGS

FIG. 1 illustrates one embodiment of a semantic appliance control system

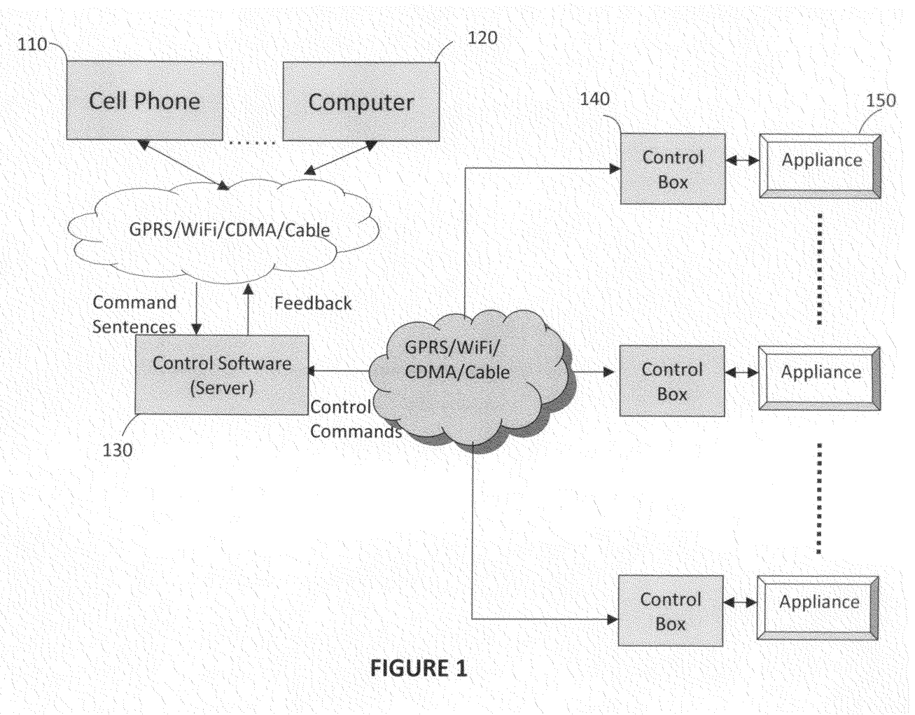

FIG. 2 illustrates one embodiment of the command sentence composition process

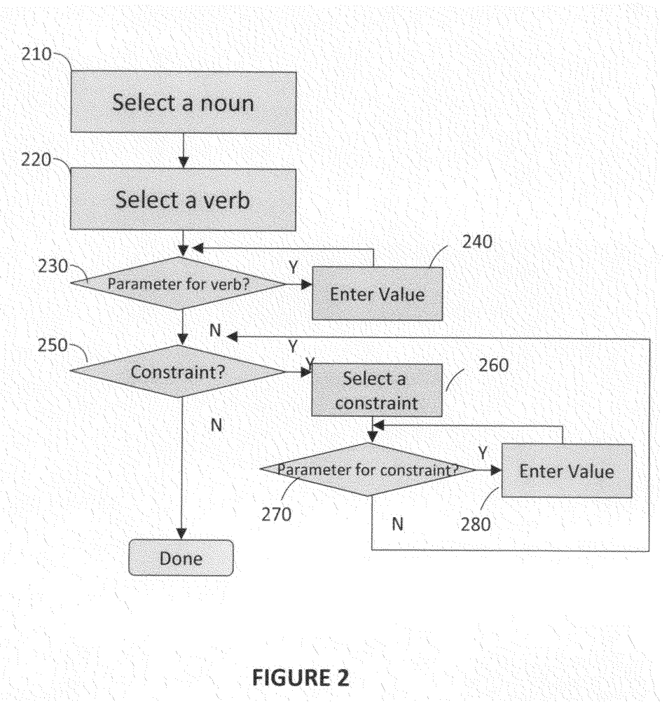

FIG. 3 illustrates one embodiment of the rule sentence composition process

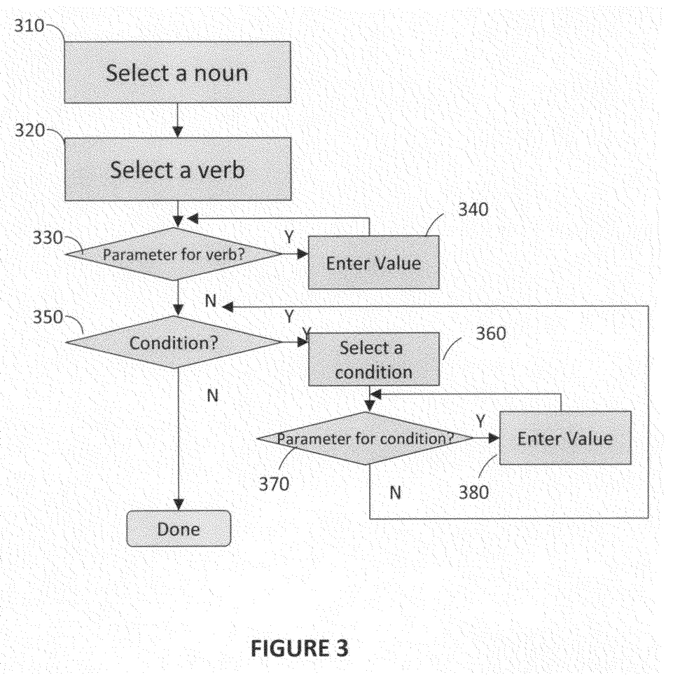

FIG. 4 illustrates one embodiment of composition process for another style of rules

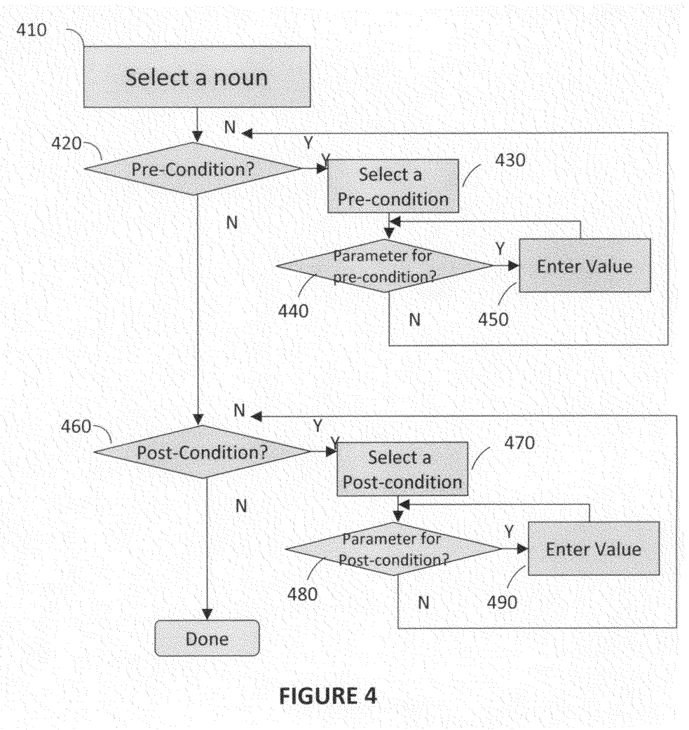

FIG. 5 illustrates one embodiment of a control box

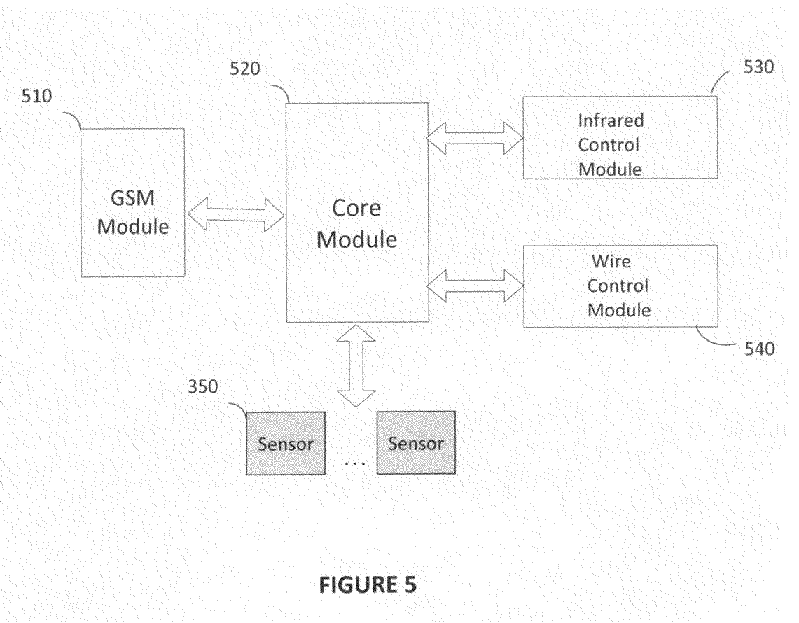

FIG. 6 illustrates one embodiment of an infrared control module

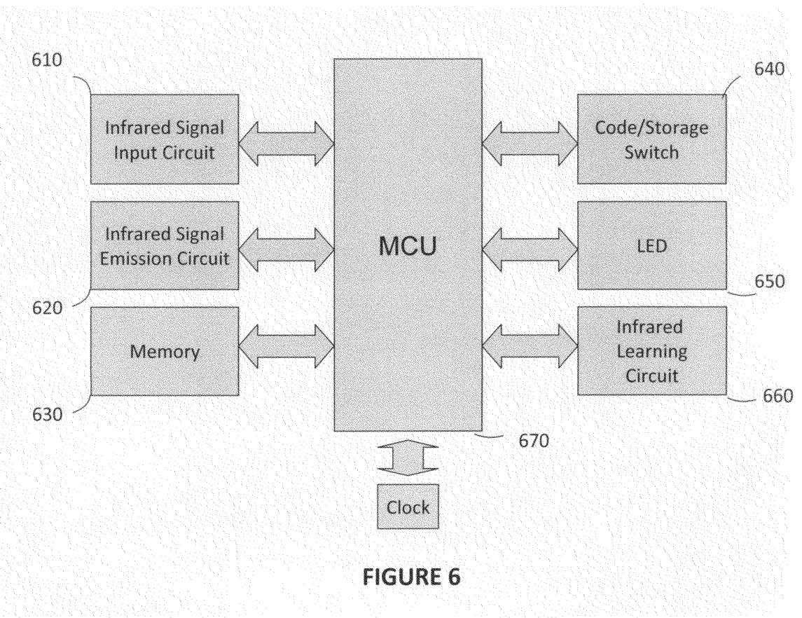

What is claimed is:

1. A semantic appliance control system, the system comprising
a computer or cellphone interface that can be connected to a server using a communication network and that allows a user to compose command sentences remotely;
one or more control boxes that each can send and/receive control signals to/from one or more specific appliances and that is connected to a server using a communication network;
a control software on a server that receives and compiles a command sentence from a user into one or more control commands; it further schedules the control commands from one or more users and sends each control command to one or more control boxes at one or more scheduled times.

2. The system of claim 1, further comprising that the cellphone interface communicates with the control software with a cellphone communication network using a cellphone communication protocol (e.g., CDMA, GPRS).

3. The system of claim 1, further comprising that the computer interface communicates with the control software with a computer communication network using a computer communication protocol (e.g., WiFi, HTTP).

4. The system of claim 1, further comprising that a control box communicates with the control software with a cellphone communication network, a computer network or a cable network.

5. The system of claim 1, further comprising that a control box is able to receive and translate a control command sent from the control software into one or more control signals, and send the signals to one or more appliances with a wire or without a wire using infrared, blue tooth, or a similar technology.

6. The system of claim 1, further comprising that a control box includes one or more sensors and is able to send the value of a sensor to the control software periodically, upon request, or automatically (when the value satisfies one or more conditions).

7. The system of claim 1, further comprising that a control box is able to receive and translate signals sent from one or more appliances, and send the translated value to the control software periodically, upon request, or automatically (when the value satisfies one or more conditions).

8. The system of claim 1, further comprising that a control box is able to learn the control signals of an appliance from the appliance's remote controller.

9. The system of claim 1, further comprising that a control box is a device separated from its associated appliance or a device embedded into an appliance.

10. The system of claim 1, further comprising a master control box in between the control software and a set of control boxes; the master control box receives commands from the control software and in turn controls the set of control boxes.

11. The system of claim 10, further comprising that the master control box communicates with the control software with a cellphone communication network, a computer communication network or a cable communication network.

12. The system of claim 10, further comprising that the master control box communicates with its associated control boxes using a cellphone communication network, a computer communication network, or a cable communication network.

13. A method of controlling an appliance remotely, the method comprising
a user composes a command sentence or a rule sentence from a cellphone or a computer and sends it to a control software on a remote server via a communication network;
the control software receives and compiles the command sentence or rule sentence into one or more control commands; it further schedules the control commands and sends each control command to one or more control boxes at one or more scheduled times via a communication network;
a control box receives and translates a control command into one or more (wired or wireless) control signals and sends the signals to one or more appliances.

14. The method of claim 13, further comprising a computer-implemented method of composing a command sentence, the method comprising:
prompting a user to select a target appliance from at least a set of defined targets;
prompting a user to select a command from at least a set of defined commands;
prompting the user to specify one or more arguments for the selected command;
prompting the user to select one or more constraints from at least a set of defined constraints;
prompting the user to specify one or more parameters for each selected constraint; and
combining the above into a command sentence.

15. The method of claim 14, further comprising that a user can enter a command sentence directly.

16. The method of claim 13, further comprising a computer-implemented method of composing a rule sentence, the method comprising:
prompting a user to select a target appliance from at least a set of defined targets;
prompting the user to select one or more conditions from at least a set of defined conditions;
prompting the user to specify one or more parameters for each selected conditions;
prompting a user to select a command from at least a set of defined commands;
prompting the user to specify one or more arguments for the selected command; and
combining the above into a rule sentence.

17. The method of claim 16, further comprising that a user can enter a rule sentence directly.

18. The method of claim 13, further comprising a computer-implemented method of composing a rule sentence, the method comprising:
prompting a user to select a target appliance from at least a set of defined targets;
prompting the user to select one or more pre-conditions from at least a set of defined pre-conditions;
prompting the user to specify one or more parameters for each selected pre-conditions;
prompting the user to select one or more post-conditions from at least a set of defined post-conditions;
prompting the user to specify one or more parameters for each selected post-conditions; and
combining the above into a rule sentence.

19. The method of claim 18, further comprising that a user can enter a rule sentence directly.

20. The method of claim 13, further comprising that a control command is sent from the control software to a master control box first, and the master control box sends it to a control box.

21. A method of controlling an appliance remotely, the method comprising
a message containing the value of an environment variable or the state of an appliance is sent from a control box to the control software directly or indirectly via a master control box;
the control software triggers zero, one or more applicable rules based on the value received.
